(19) United States
(12) Patent Application Publication
(10) Pub. No.: US 2013/0317754 A1
(43) Pub. Date: Nov. 28, 2013

(54) MACHINE-IMPLEMENTED METHOD FOR ANALYZING GENOME-WIDE GENE EXPRESSION PROFILING

(71) Applicant: NATIONAL CHUNG CHENG UNIVERSITY, Chia-Yi County (TW)

(72) Inventors: Cheng-Chung Chou, New Taipei City (TW); Chi- Wei Tseng, Taichung City (TW)

(73) Assignee: National Chung Cheng University, Chia-Yi County (TW)

(21) Appl. No.: 13/728,291

(22) Filed: Dec. 27, 2012

(30) Foreign Application Priority Data
May 24, 2012 (TW) 101118539

(51) Int. Cl. G06F 19/26

(52) U.S. Cl. CPC G06F 19/26
USPC 702/19

(57) ABSTRACT

A machine-implemented method for analyzing a genome-wide gene expression profiling includes: searching at least one pathway database using genes in the genome-wide gene expression profiling as an index to find pathways; screening the pathways according to expression levels of the genes in the genome-wide gene expression profiling for identifying screened pathways that have statistical significance; establishing pathway sets according to the genes associated with the screened pathways; and determining biological information of the genes that are common to the screened pathways in the pathway set by making reference to correlation between the genes and gene ontology terms.

### CROSS-REFERENCE TO RELATED APPLICATION

This application claims priority to Taiwanese Application No. 101118539, filed on May 24, 2012.

### BACKGROUND OF THE INVENTION

1. Field of the Invention

The invention relates to a machine-implemented method for analysis, and more particularly to a machine-implemented method for analyzing a genome-wide gene expression profiling.

2. Description of the Related Art

In conventional gene expression analysis, genes that have abnormal expression levels are first screened out for further function analysis, and a specific threshold value or a statistical test may be used in the screening method. However, using the same screening criteria is inappropriate since properties may vary among different genes.

Moreover, interactions between genes are not considered in the conventional analysis method. Protein-Protein interaction network analysis is generally utilized for this consideration. However, the network established thereby is complicated, resulting in difficulty in annotation and lack of biological significance. When biological pathways are used for analysis, compared to the Protein-Protein interaction network analysis, the obtained results may have more biological significance, but currently this method only focuses on reactions of genes involved in a single biological phenomenon, and is unable to analyze interactions between biological pathways with different reaction levels in a systematized manner.

Furthermore, if only Gene Ontology is used to understand the effects of genes on biological functions, the annotations of the gene functions may be too complicated since the Gene Ontology classifies genes in three different domains using a level structure relationship, and a single gene may be involved in different biological events which fall into different levels, resulting in difficulty in annotation of the biological significance.

### SUMMARY OF THE INVENTION

Therefore, an object of the present invention is to provide a machine-implemented method for analyzing a genome-wide gene expression profiling based on biological pathways and Gene Ontology.

According to the present invention, a machine-implemented method for analyzing a genome-wide gene expression profiling comprises:

a) searching at least one pathway database using genes in the genome-wide gene expression profiling as an index to find pathways;

b) screening the pathways found in step a) according to expression levels of the genes in the genome-wide gene expression profiling for identifying screened pathways that have statistical significance;

c) establishing pathway sets according to the genes associated with the screened pathways identified in step b), each of the pathway sets including a portion of the screened pathways; and

d) determining, for each of the pathway sets, biological information of the genes that are common to at least two of the screened pathways in the pathway set, wherein the determining of the biological information makes reference to correlation between at least one of the genes and gene ontology (GO) terms.

### BRIEF DESCRIPTION OF THE DRAWINGS

Other features and advantages of the present invention will become apparent in the following detailed description of the preferred embodiment with reference to the accompanying drawings, of which:

FIGS. 1 (A) and 1 (B) are a flow chart illustrating steps of a preferred embodiment of the machine-implemented method for analyzing a genome-wide gene expression profiling according to the present invention;

FIGS. 2(A) and 2(B) are a schematic diagram illustrating a process of establishing a dendrogram relationship using the preferred embodiment;

FIG. 3 is a schematic diagram illustrating the dendrogram relationship established using the preferred embodiment and screened pathway sets;

FIG. 4 is a schematic diagram illustrating a GO tree relationship established using the preferred embodiment;

FIG. 5 is a screenshot showing analysis results associated with biological process determined using the preferred embodiment;

FIG. 6 is a screenshot showing analysis results associated with molecular function determined using the preferred embodiment;

FIG. 7 is a screenshot showing analysis results associated with cellular component determined using the preferred embodiment; and

FIG. 8 illustrates that TiO₂ nanoparticles lead to DNA damage of macrophages.

### DETAILED DESCRIPTION OF THE PREFERRED EMBODIMENT

According to the present invention, a preferred embodiment of the method for analyzing a genome-wide gene expression profiling is implemented by a machine with a proprietary program. In practice, the application of this invention may be a machine-readable storage medium product stored with the program, which is installed into and executed by an electronic device, such as a personal computer, for implementing the method of this invention.

A toxic mechanism of TiO₂ nanoparticles on macrophages is exemplified herein for illustrating the method of this invention.

The macrophages are differentiated from THP-1 cells cultivated using a conditioned medium in a 6-well plate with 6×10⁵ cells in each well. A 2.5 mg/ml high-concentration stock of TiO₂ is produced by suspending 2.5 mg of TiO₂ in 1 ml of 10% pluronic F-68. Then, the stock is sonicated for 30 minutes, followed by disinfection under 121° C. for 20 minutes using a sterilizer for ensuring a microbe-free condition before being diluted for usage. A method for acquiring gene expression data includes cultivation of the macrophages, RNA extraction, cRNA synthesis, labeling, fragmentation, and gene chip hybridization. First, after the THP-1 cells are converted into the macrophages, the macrophages are cultivated in a high glucose RPMI 1640 medium in a 6-well plate under an environment of 37° C., 5% CO₂, and pH 7.2 for three days. Then, the TiO, stock is diluted using a serum-free high glucose RPMI 1640 medium to obtain 50 μg/ml of a diluted TiO₂ solution. In an experimental group, each well is given with 2.5 ml of the diluted TiO₂ solution. In a control group, each well is given with 2.5 ml of the serum-free high glucose RPMI 1640 medium. After cultivation of the macrophages in the experimental group and the control group under the environment of 37° C., 5% CO₂, and pH 7.2 for 24 hours, the macrophages were washed using phosphate buffered saline (PBS) for three times for the following RNA extraction. During RNA extraction, total RNAs of the macrophages were isolated using TRIzol (Invitrogen corporation). Amplification and labeling of the RNA samples, on-chip hybridization, and reading and normalization of chip signals were consigned to Genetech Biotech Co., Ltd. Each probe on the chip is a DNA sequence with a specific length, usually a fragment of a specific gene, such that multiple probes may refer to a same gene. To solve this problem, signal intensities of the probes that refer to a same gene are averaged to represent an expression data of the gene.

In the preferred embodiment, a gene chip, Human-WG6, produced by Illumina Inc. was adopted as an expression data source, and was used to obtain 36,160 effective expression data. After averaging the expression data from the probes that refer to a same gene, 24,927 of the effective expression data remained. The expression data will not be listed herein due to the extremely large number thereof.

The method of this invention is adapted for a plurality of genes in the genome-wide gene expression profiling, which respectively correspond to a gene expression level. Each gene expression level is computed based on the logarithm (base 2) of the gene expression ratio between the experimental group and the control group. The expression ratio data may be acquired from any bio-chip platform or high-throughput sequencing.

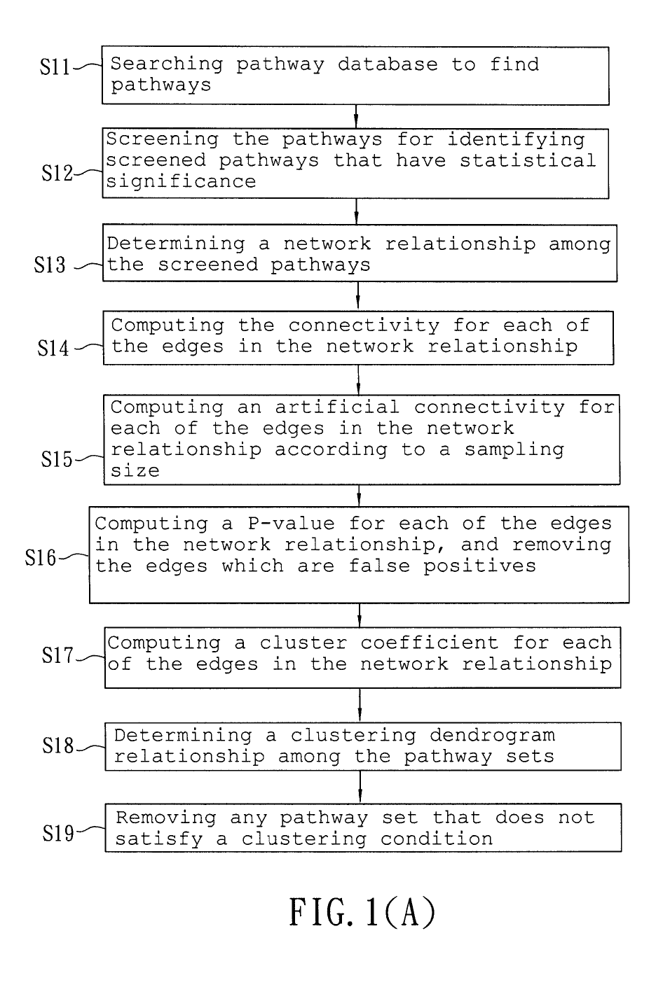

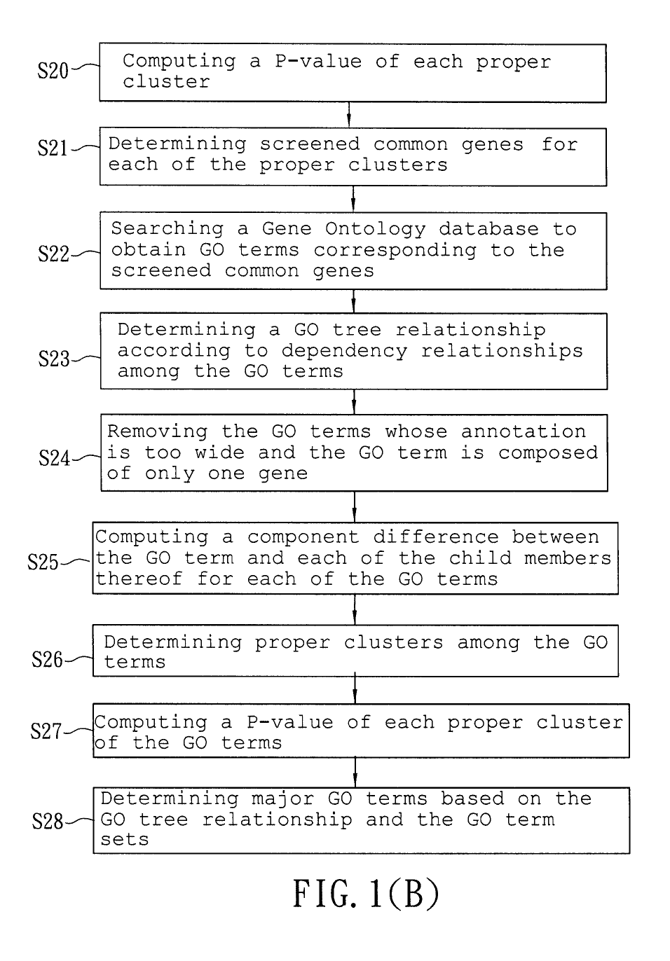

FIGS. 1 (A) and 1 (B) illustrate steps of the method of this embodiment, the details of which are described hereinafter.

Step S11: Pathways are found by searching at least one pathway database using genes in the genome-wide gene expression profiling as an index, and each pathway is associated with a plurality of genes. In this embodiment, the pathway database includes Kyoto Encyclopedia of Genes and Genomes (KEGG) and a public pathway database of BioCarta, and 514 known pathways are found by using homo sapiens as a target species, of which 200 are from KEGG, and the other 314 are from BioCarta. Different pathway databases may have different definitions of the gene information, and symbols and code names used thereby may belong to different systems. In this embodiment, a database provided by National Center for Biotechnology Information (NCBI) and a network service provided by Database for Annotation, Visualization and Integrated Discovery (DAVID) are used to search corresponding relationships between different symbol systems.

It should be noted that the pathway database may be a metabolic pathway database or a signal transduction database.

Step S12: The pathways found in step S11 are screened according to expression levels of the genes in the genome-wide gene expression profiling for identifying screened pathways that have statistical significance. Each pathway p has a pathway activity score Sₚ, which may be obtained using:

$${S}_{p} = {\sum }_{g ∈ p} \vert {log}_{2} ( \overline{g} ) \vert$$

where g̅ is the expression ratio between the experimental group and the control group of a gene (g) involved in the reaction associated with the pathway p.

Then, each pathway is evaluated whether or not it has statistical significance via simulation. The simulation is performed by randomly selecting a plurality of genes having a same number as that associated with the pathway p to generate a simulation pathway, and computing a pathway activity score Sₚₛ of the simulation pathway. A P-value Pₚ is computed using the following equation with a sampling size M being 10⁵:

$${P}_{p} = \frac{{\sum }_{i = 1}^{M} {I}_{i}}{M} , and {I}_{i} = \{ \begin{matrix}1 \vert {S}_{ p s} \geq {S}_{p} \\ 0 \vert {S}_{p s} < {S}_{p}\end{matrix} \}$$

Assuming there are r pathways satisfying Pₚ<0.05, a Q-value P_{Q} is computed through multiple testing correction using the following equation. The pathway p is determined to have statistical significance if P_{Q}<0.05.

$${P}_{Q} = \frac{{P}_{P} \times N}{rank ( {P}_{P} )}$$

where N is a total number of the known pathways of the species, and rank(Pₚ) represents an ascending power order of r P-values Pₚ. In this preferred embodiment, the statistical significances of the 514 pathways are all evaluated using sampling simulation, and 117 pathways thereamong that satisfy Pₚ<0.05 are obtained. After the ascending power order arrangement of the 117 pathways, 46 pathways thereamong that satisfy P_{Q}<0.05 are obtained through multiple testing correction, and are listed in the following table:

| | Name of Pathway | P value | Q value |
|---|---|---|---|
| 1 | Role of Ran in mitotic | 0.00001 | 0.000571 |
| | spindle regulation | | |
| 2 | Nucleotide excision | 0.00001 | 0.000571 |
| | repair | | |
| 3 | Mismatch repair | 0.00001 | 0.000571 |
| 4 | Epithelial cell | 0.00003 | 0.001285 |
| | signaling in | | |
| | Helicobacter pylori | | |
| | infection | | |
| 5 | Cell Cycle: G2/M | 0.00004 | 0.001582 |
| | Checkpoint | | |
| 6 | TSP-1 Induced | 0.00004 | 0.001582 |
| | Apoptosis in | | |
| | Microvascular | | |
| | Endothelial Cell | | |
| 7 | Other glycan | 0.00004 | 0.001582 |
| | degradation | | |
| 8 | p53 signaling pathway | 0.00004 | 0.001582 |
| 9 | RB Tumor | 0.00008 | 0.002419 |
| | Suppressor/Checkpoint | | |
| | Signaling in response | | |
| | to DNA damage | | |
| 10 | Signal transduction | 0.0001 | 0.002856 |
| | through IL1R | | |
| 11 | Bladder cancer | 0.0001 | 0.002856 |
| 12 | cdc25 and chk1 | 0.00015 | 0.003855 |
| | Regulatory Pathway in | | |
| | response to DNA | | |
| | damage | | |
| 13 | CDK Regulation of | 0.000009 | 0.004626 |
| | DNA Replication | | |
| 14 | Purine metabolism | 0.000009 | 0.004626 |
| 15 | Pyrimidine | 0.000009 | 0.004626 |
| | metabolism | | |
| 16 | Ribosome | 0.000009 | 0.004626 |
| 17 | DNA replication | 0.000009 | 0.004626 |
| 18 | Base excision repair | 0.000009 | 0.004626 |
| 19 | Cytokine-cytokine | 0.000009 | 0.004626 |
| | receptor interaction | | |
| 20 | Cell cycle | 0.000009 | 0.004626 |
| 21 | Homologous | 0.00021 | 0.00514 |
| | recombination | | |
| 22 | Classical Complement | 0.00028 | 0.006542 |
| | Pathway | | |
| 23 | Regulation of p27 | 0.0003 | 0.006704 |
| | Phosphorylation | | |
| | during Cell Cycle | | |
| | Progression | | |
| 24 | Cell Cycle: G1/S | 0.00055 | 0.011779 |
| | Check Point | | |
| 25 | Pathways in cancer | 0.00066 | 0.01357 |
| 26 | Biosynthesis of | 0.00082 | 0.01561 |
| | steroids | | |
| 27 | Toll-like receptor | 0.00079 | 0.015618 |
| | signaling pathway | | |
| 28 | Activation of Src by | 0.00104 | 0.019091 |
| | Protein-tyrosine | | |
| | phosphatase alpha | | |
| 29 | Complement and | 0.00109 | 0.019319 |
| | coagulation cascades | | |
| 30 | One carbon pool by | 0.00117 | 0.020046 |
| | folate | | |
| 31 | Cycling of Ran in | 0.00134 | 0.022218 |
| | nucleocytoplasmic | | |
| | transport | | |
| 32 | Complement Pathway | 0.00145 | 0.022585 |
| 33 | Adhesion and | 0.00144 | 0.02313 |
| | Diapedesis of | | |
| | Granulocytes | | |
| 34 | Glycosphingolipid | 0.00168 | 0.025398 |
| | biosynthesis - ganglio | | |
| | series | | |
| 35 | Adhesion and | 0.00178 | 0.026141 |
| | Diapedesis of | | |
| | Lymphocytes | | |
| 36 | Sonic Hedgehog | 0.00194 | 0.027699 |
| | (SHH) Receptor Ptc1 | | |
| | Regulates cell cycle | | |
| 37 | Glutathione | 0.00228 | 0.031674 |
| | metabolism | | |
| 38 | Estrogen-responsive | 0.00235 | 0.031787 |
| | protein Efp controls | | |
| | cell cycle and breast | | |
| | tumors growth | | |
| 39 | Systemic lupus | 0.00235 | 0.031787 |
| | erythematosus | | |
| 40 | Cyclins and Cell Cycle | 0.00282 | 0.036237 |
| | Regulation | | |
| 41 | TNFR1 Signaling | 0.00299 | 0.037484 |
| | Pathway | | |
| 42 | Cadmium induces | 0.00329 | 0.040263 |
| | DNA synthesis and | | |
| | proliferation in | | |
| | macrophages | | |
| 43 | Cells and Molecules | 0.00354 | 0.042315 |
| | involved in local acute | | |
| | inflammatory response | | |
| 44 | NFkB activation by | 0.00376 | 0.043924 |
| | Nontypeable | | |
| | Hemophilus influenzae | | |
| 45 | Eicosanoid | 0.00397 | 0.045346 |
| | Metabolism | | |
| 46 | Aminosugars | 0.00413 | 0.046148 |
| | metabolism | | |

Step S13: A network relationship is determined among the screened pathways. In the network relationship, each of the screened pathways is associated with a vertex, and a pair of the screened pathways that are commonly associated with common genes are linked together by an edge.

Step S14: For each of the edges e, the connectivity Ce is computed based on the gene expression level of the gene associated with the edge using the following equation:

$${C}_{e} = {C}_{m , n} = \frac{{\sum }_{g ∈ m ⋂ n} \vert {log}_{2} ( \overline{g} ) \vert}{min [ {S}_{m} , {S}_{n} ]}$$

where e is an edge linking a pathway m and a pathway n, m∩n is a set of the genes commonly associated with the pathway m and the pathway n, g̅ is the expression ratio between the experimental group and the control group of a gene (g) commonly associated with the pathway in and the pathway n, Sₘ is the pathway activity score of the pathway m, and Sₙ is the pathway activity score of the pathway n.

Step S15: For each of the edges e, an artificial connectivity C_{artif} is computed according to randomly selected genes having a same number as that of the genes associated with the edge from total gene expression data using the following equation:

$${C}_{artif} = \frac{{\sum }_{g ∈ o} \vert {log}_{2} ( \overline{g} ) \vert}{min [ {S}_{m} , {S}_{n} ]}$$

where o is the set composed of the randomly selected genes.

Step S16: Step S15 is repeated according to a sampling size, and for each of the edges e, a P-value Pₑ is computed according to results of repetitions of step 15 using the following equation:

$${P}_{e} = \frac{{\sum }_{k = 1}^{M} {I}_{k}}{M} , and {I}_{k} = \{ \begin{matrix}1 \vert {C}_{e} \geq {C}_{artif} \\ 0 \vert {C}_{e} < {C}_{artif}\end{matrix} \}$$

where M is the sampling size.

Then, any edge e whose P-value is greater than a predetermined value is removed from the network relationship.

In this preferred embodiment, the predetermined value is 0.05, and the sampling size M is 10⁵. Step S15 is repeated to obtain 10⁵ artificial connectivities C_{artif} for comparing with the connectivity Cₑ to obtain the P-value Pₑ. If the P-value Pₑ is not smaller than 0.05, the edge e is considered to be false positive, which means that the edge e has no statistical significance, and is thus removed from the network relationship.

Step S17: After step S16, for each of the edges e remaining in the network relationship, a cluster coefficient Wₑ is computed based on the connectivity Cₑ of the edge e using the following equation:

$${W}_{e} = {W}_{m , n} = \frac{\frac{1}{{2}^{0}} \times {C}_{m , n} + \frac{1}{{2}^{1}} \times {\sum }_{k ∈ {N}_{m} ⋂ {N}_{n}} \frac{{C}_{m , k} + {C}_{k , n}}{2}}{min [ {\sum }_{i ∈ {N}_{m}} {C}_{m , i} , {\sum }_{j ∈ {N}_{n}} {C}_{, j} ]}$$

where Nₘ is a set composed of all of the vertices that are connected to the vertex associated with the pathway m, and Nₙ is a set composed of all of the vertices that are connected to the vertex associated with the pathway n.

Step S18: A clustering dendrogram relationship is determined among the pathway sets according to the cluster coefficients computed in Step S17. Each node of the clustering dendrogram relationship is associated with a pathway set that includes at least one of the screened pathways. During determination of the clustering dendrogram relationship, the edge e having the smallest clustering coefficient Wₑis first removed from the network relationship. If there are a plurality of the edges e having the same clustering coefficient Wₑ, the one having the smallest connectivity Cₑ is removed from the network relationship. If the edges e having the same clustering coefficient Wₑ still have the same connectivity Cₑ, the one to be removed from the network relationship is determined according to ratio of the common genes therein. For example, there are two edges e₁ and e₂ having a same clustering coefficient. The edge e₁ that is associated with a pathway “a” and a pathway “b” has a connectivity Cₑ₁, and the genes common to the pathways “a” and “b” form a set “s”. The edge e₂ that is associated with a pathway “c” and a pathway “d” has a connectivity Cₐ, which is equal to Cₑ₁, and the genes common to the pathways “c” and “d” form a set “t”. According to definition of the connectivity, “Cₑ₁=Cₑ₂” means that “Sₛ/min(Sₐ,S_{b})=Sₜ/min(S_{c},S_{d})”. Further referring to the ratio of the common genes thereof, when Sₛ/min(Sₐ,S_{b})<Sₜ/min(S_{c},S_{d}), the edge e₁ is removed from the network relationship. Otherwise, the edge e₂ is removed from the network relationship. At this time, if the network relationship is divided into two sub-network relationships due to removal of the edge e, two nodes are established in the clustering dendrogram relationship, and each of the two nodes corresponds to a pathway set composed of the vertices in a respective sub-network relationship. The two nodes have a common parent node that corresponds to a pathway set composed of the vertices in the network relationship, which has yet to be divided. Then, following the aforesaid description of checking the network relationship to check each of the sub-network relationships, the flow is repeated until all of the edges e in each sub-network relationship are removed, so as to complete establishing the clustering dendrogram relationship.

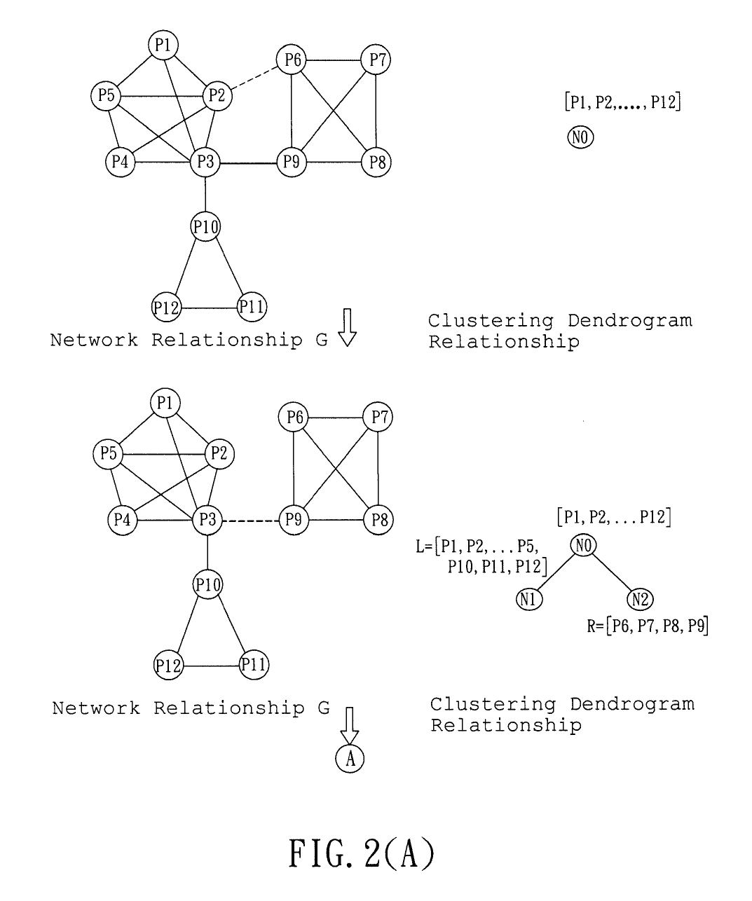

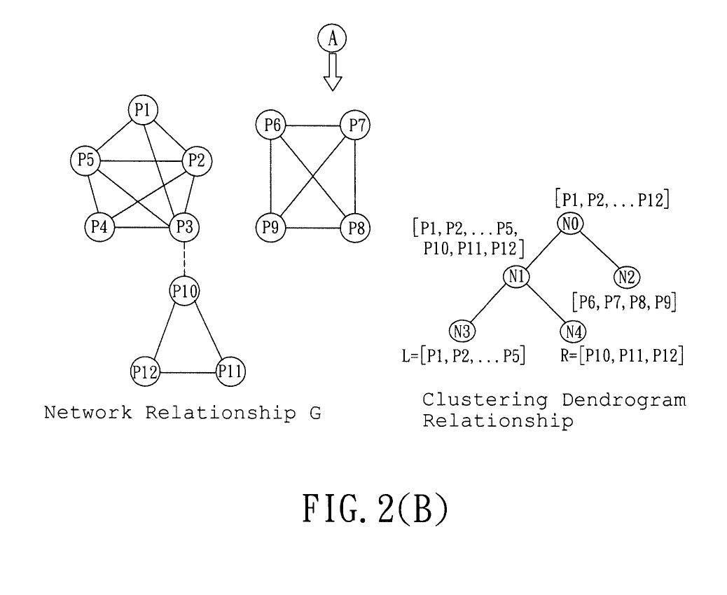

Referring to FIGS. 2(A) and 2(B) as an example, a network relationship G includes vertices P1 to P12. A node N0 corresponding to all of the vertices in the network relationship G is first established in the clustering dendrogram relationship. The edge e(2,6) (referred to an edge connecting the vertices P2 and P6) in the network relationship G has the smallest clustering coefficient Wₑ, and the edge e(3,9) (referred to an edge connecting the vertices P3 and P9) in the network relationship G has the second smallest clustering coefficient Wₑ, so that the edge e(2,6) is first removed, and the edge e(3,9) is then removed. The removal of the edge e(3,9) results in division of the network relationship G into two sub-network relationships, thus a node N1 and a node N2 that respectively correspond to a pathway set [P1, P2, P3, P4, P5, P10, P11, P12] and a pathway set [P6, P7, P8, P9] are established in the clustering dendrogram relationship. Then, the edge e(3,10) becomes the edge e having the smallest clustering coefficient Wₑ. When the edge e(3,10) is removed, the sub-network relationship including the vertices P1, P2, P3, P4, P5, P10, P11, and P12 is divided into two parts. Since the pathway set composed of the vertices P1, P2, P3, P4, P5, P10, P11, and P12 corresponds to the node N1, a node N3 and a node N4 that respectively correspond to a pathway set [P1, P2, P3, P4, P5] and a pathway set [P10, P11, P12] are established under the node N1. By similar operations, the edges e are removed one by one according to the clustering coefficients Wₑ until all of the edges e are removed from the network relationship, and the clustering dendrogram relationship is completely established. In the clustering dendrogram relationship, each node corresponds to a pathway set composed of at least one of the vertices, each vertex in a pathway set corresponds to one of the screened pathways, and each pathway set that corresponds to any one of the nodes in the clustering dendrogram relationship is a union of the pathway sets corresponding to all of the child nodes of said any one of the nodes. In addition, a pathway set corresponding to any one leaf node in the clustering dendrogram relationship includes a single vertex that corresponds to a signal pathway.

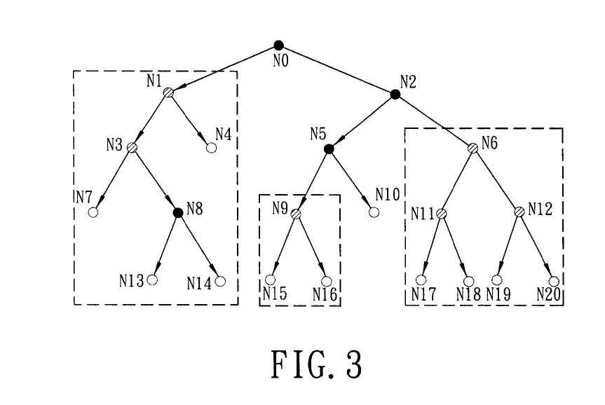

Step S19: Any pathway set that does not satisfy a clustering condition is removed from the clustering dendrogram relationship. Referring to FIG. 3, except for the leaf nodes, each of the nodes in the clustering dendrogram relationship is checked whether the corresponding pathway set is a proper cluster using the following inequality:

$$\frac{{\sum }_{i ∈ L} {\sum }_{j ∈ R} {C}_{i , j}}{\vert L \vert \times \vert R \vert \times \frac{{\sum }_{e ∈ E} {C}_{e}}{\vert E \vert}} \geq 0.1$$

where L is a pathway set corresponding to a left child node of the node, R is a pathway set corresponding to a right child node of the node, and E is a set composed of the edges e in the network relationship. This is for inspecting whether interaction of the vertices between the pathway set L and the pathway set R reaches a specific level.

When both of the pathway sets L, R or one of them includes only one vertex, which means the vertex is a dangling vertex before division of the network relationship, the inequality is modified to be:

$${C}_{{e}_{1 }} \geq \frac{{\sum }_{e ∈ E} {C}_{e}}{\vert E \vert} - {Std}_{E}$$

where Std_{E} is a standard deviation of the connectivties of all of the edges e in the network relationship, and eᵢ is the edge connected to the dangling vertex.

If the node satisfies the inequality, all of the nodes included in a child tree which has the inequality-satisfying node as a root node thereof are judged whether they also satisfy the inequality. It is determined that the pathway set corresponding to the node is not a proper cluster when any one of the nodes included in the child tree which has the inequality-satisfying node as the root node thereof does not satisfy the inequality.

Referring to FIG. 3 as an example, the nodes that do not satisfy the inequality are colored in black, the nodes that satisfy the inequality are filled with slashes, and the leaf nodes are colored in white. The pathway set corresponding to a leaf node only corresponds to a single pathway, and is thus not discussed herein. In this example, the node N1 satisfies the inequality, but the node N8 in a child tree thereof does not satisfy the inequality, so that the pathway set corresponding to the node N1 is not a proper cluster. Based on the same reason, although the node N3 satisfies the inequality, the corresponding pathway set is not a proper cluster. On the other hand, all of the nodes under the nodes N6 and N9 satisfy the inequality, so that the pathway sets corresponding to the nodes N6 and N9 are determined to be proper clusters. In this preferred embodiment, 9 of the 46 screened pathways are removed, and the remaining 37 screened pathways are divided into 8 clusters.

In step S20 illustrated in FIG. 1(B), a P-value of each proper cluster is computed using the same way illustrated in step S15. If one of the proper clusters includes M pathways that form a network relationship having N edges among the M pathways, a proper clustering score is first obtained by sum of the connectivities Cₑ of the N edges. For each sampling, M pathways are randomly selected from the whole network, and form a sub-network having N_{artif} edges, followed by computing a sum of connectivities Cₑ of the N_{artif} edges to obtain a sampling clustering score, and comparing the proper clustering score and the sampling clustering score for completion of sampling computation for a single time. Then, the sampling computation is repeated according to the sampling size to compute the P-value of the proper cluster, and the multiple testing correction is performed on the P-value of the proper cluster in a Bonferroni manner.

The Bonferroni corrected P-value=the P-value×number of the clusters. In this embodiment, after the multiple testing correction is performed on the 8 proper clusters, it is found that there are 5 major proper clusters thereamong, which satisfy the condition that the corrected P-value is smaller than 0.05. The 5 major proper clusters are as listed in the following table:

| | | Bonferroni |
|---|---|---|
| Cluster | Pathway | Correction |
| 1 | Cell Cycle: G2/M Checkpoint | 0.0032 |
| | RB Tumor Suppressor/Checkpoint | |
| | Signaling in response to DNA | |
| | damage | |
| | cdc25 and chk1 Regulatory Pathway | |
| | in response to DNA damage | |
| 2 | Complement Pathway | 0.00072 |
| | Classical Complement Pathway | |
| | Complement and coagulation | |
| | cascades | |
| | Systemic lupus erythematosus | |
| 3 | Regulation of p27 Phosphorylation | 0.0384 |
| | during Cell Cycle Progression | |
| | Pathways in cancer | |
| | Base excision repair | |
| | CDK Regulation of DNA | |
| | Replication | |
| | DNA replication | |
| | Homologous recombination | |
| | Eicosanoid Metabolism | |
| | Cell cycle | |
| | Cadmium induces DNA synthesis | |
| | and proliferation in macrophages | |
| | Nucleotide excision repair | |
| | Mismatch repair | |
| 4 | Toll-like receptor signaling pathway | 0.0472 |
| | NFkB activation by Nontypeable | |
| | Hemophilus influenzae | |
| | Signal transduction through IL1R | |
| 5 | Cytokine-cytokine receptor | 0.0056 |
| | interaction | |
| | Adhesion and Diapedesis of | |
| | Granulocytes | |
| | Cells and Molecules involved in | |
| | local acute inflammatory response | |
| | Adhesion and Diapedesis of | |
| | Lymphocytes | |

Hereinafter, the major proper clusters are analyzed with Gene Ontology for further finding biological significance of each major proper cluster by performing the following steps.

Step S21: Screened common genes that are commonly associated with at least two of the screened pathways are determined for each pathway set which is a proper cluster. For example, one of the pathway sets, which is a proper cluster, includes pathways P1, P2, and P3. The pathways P1 and P2 have screened common genes g1, g2, g3, and g5. The pathways P1 and P3 have screened common genes g2 and g5. The pathways P2 and P3 have screened common genes g2, g4, and g5. Therefore, the screened common genes of the pathway set are the union thereof and include the genes g1, g2, g3, g4, and g5.

Step S22: A Gene Ontology (GO) database is searched to obtain GO terms corresponding to the screened common genes. The GO database includes three ontology domains: biological process, molecular function, and cellular component. Each of the GO terms belongs to one of the ontology domains.

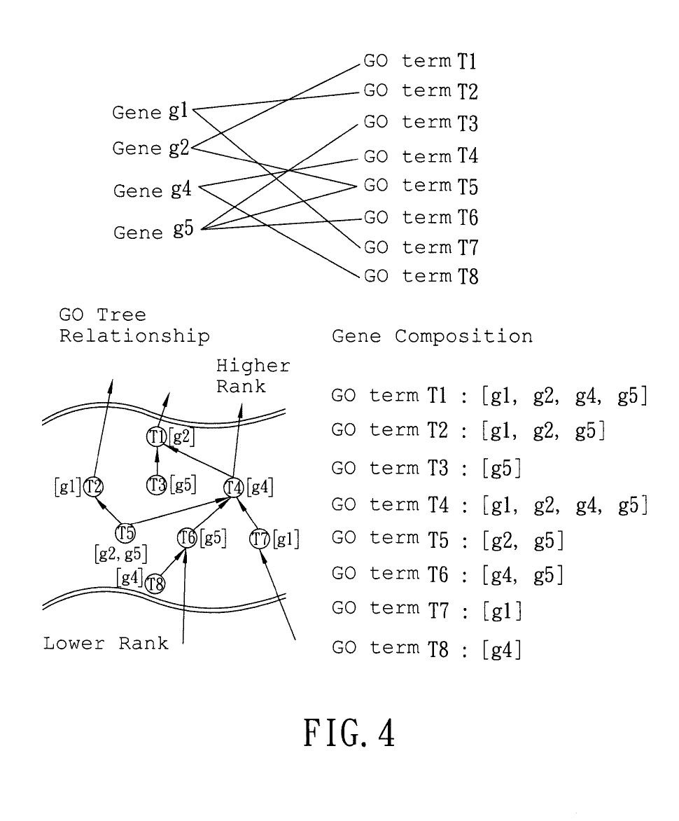

Step S23: Referring to FIGS. 1(B) and 4, a GO tree relationship is determined according to dependency relationships among the GO terms. A lower-ranked one of two of the GO terms having a direct dependency relationship therebetween is defined as a child member of a higher-ranked one of said two of the GO terms. In the GO tree relationship, each of the GO terms is associated with a tree node, and has a gene composition that is composed of the screened common genes and that corresponds to the GO term and the child member thereof.

Following the aforesaid example, the screened common genes obtained from the proper cluster are the genes g1, g2, g3, g4, and g5. According to the GO database, the gene g1 corresponds to the GO terms T2 and T7, the gene g2 corresponds to the GO terms T1 and T5, the gene g3 does not correspond to any GO term, the gene g4 corresponds to the GO terms T4 and T8, and the gene g5 corresponds to the GO terms T3, T5, and T6. Viewing from the genes, the GO term T1 corresponds to the gene g2, the GO term T2 corresponds to the gene g1, the GO term T3 corresponds to the gene g5, the GO term T4 corresponds to the gene g4, the GO term T5 corresponds to the genes g2 and g5, the GO term T6 corresponds to the gene g5, the GO term T7 corresponds to the gene g1, and the GO term T8 corresponds to the gene g4. According to the dependency defined in the gene ontology (is-a or part-of), the corresponding genes of the lower-ranked GO term are transferred to the higher-ranked GO term with reference to a plurality of middle-ranked GO terms, and the GO tree corresponding to the proper clusters is established by combining the middle-ranked GO terms. Finally, the GO term T1 has a gene composition composed of the genes g1, g2, g4, and g5, the GO term T2 has a gene composition composed of the genes g1, g2, and g5, the GO term T3 has a gene composition composed of the genes g5, the GO term T4 has a gene composition composed of the genes g1, g2, g4, and g5, the GO term T5 has a gene composition composed of the genes g2 and g5, the GO term T6 has a gene composition composed of the genes g4 and g5, the GO term T7 has a gene composition composed of the gene g1, and the GO term T8 has a gene composition composed of the gene g4.

Step S24: The GO terms whose annotations, according to a level of each GO term defined in the gene ontology, are too wide (the level number is smaller than 3) are removed, and the GO term composed of only one gene is removed for simplifying annotations.

Step S25: For each of the GO terms, a component difference “Diff( )” between the GO term and each of the child members thereof is computed from the highest-ranked GO term, and any GO term whose component difference is zero is removed from the GO tree relationship. The component difference “Diff( )” is a total number of differences in the screened common genes between the GO term and each of the child members thereof. The component difference “Diff( )” between the GO term 1 (T_{I}) and the GO term (T₂) may be computed using the following equation:

$${T}_{n , i} = \{ \begin{matrix}1 \vert {g}_{i} ∉ {T}_{n , i} \\ 0 \vert {g}_{i} ∈ {T}_{n , i}\end{matrix} \} , \\ Diff ( {T}_{1} , {T}_{2} ) = {\sum }_{k = 1}^{length ( SG )} {T}_{1 , k} ⊕ {T}_{2 , k}$$

where SG is a sequential group formed from the screened common genes, and T_{n,i} represents the i^{th} of the genes included in the SG relative to the n^{th} GO term.

For example, when the screened common genes are the genes g1, g2, g3, g4, and g5, the GO term T1 has a gene composition composed of the genes g1, g2, g4, and g5, and the GO term T2 has a gene composition composed of the genes g1, g2, and g5, Diff(T1, T2)=1. In another example, the GO term T1 has a gene composition composed of the genes g1, g2, g4, and g5, and the GO term T3 has a gene composition composed of the genes g5, Diff(T1, T3)=3.

Step S26: A network relationship is determined among the GO terms, by the same way illustrated in step S13. In the network relationship, each of the GO terms is associated with a vertex, and a pair of the GO terms that are commonly associated with common genes are linked together by an edge. Then, for each of the edges, the connectivity Ce is computed based on the gene expression level of the gene associated with the edge using the same equation shown in step S14. Since the edge relationship among the GO terms is defined in the gene ontology, it is not needed to test whether the edge is false positive herein. Then, for each of the edges in the network relationship, a cluster coefficient Wₑ is computed based on the connectivity Ce of the edge, by the same way illustrated in step S17. According to the computed cluster coefficients, a clustering dendrogram relationship is determined among the GO term sets, by the same way illustrated in step S18. Each of the GO term sets is associated with a node of the clustering dendrogram relationship and includes at least one of the GO terms. Any GO term set that does not satisfy a clustering condition is removed from the clustering dendrogram relationship, by the same way illustrated in step S19.

Step S27: A P-value of each proper cluster is computed using the same way illustrated in step S15. If one of the proper clusters includes M GO terms that form a network relationship having N edges among the M GO terms, a proper clustering score is first obtained by sum of the connectivities Cₑ of the N edges. For each sampling, M GO terms are randomly selected from the whole network illustrated in step S26, and form a sub-network having N_{artif} wedges, followed by computing a sum of connectivities Cₑ of the N_{artif} edges to obtain a sampling clustering score, and comparing the proper clustering score and the sampling clustering score for completion of the sampling computation for a single time. Then, the sampling computation is repeated according to the sampling size to compute the P-value of the proper cluster, and the multiple testing correction is performed on the P-value of the proper cluster in a Bonferroni manner.

In the example of the preferred embodiment, the largest of the five proper clusters that satisfy the condition that the P-value is smaller than 0.05 includes 92 screened common genes. According to the corresponding relationship from the Gene Ontology as illustrated in step S22, there are 1916 GO terms obtained from the biological process domain, 269 GO terms obtained from the molecular function domain, and 190 GO terms obtained from the cellular component domain. According to step S23, GO tree relationships of the biological process, molecular function, and cellular component are respectively established, and the GO tree relationship of the biological process is used as an example hereinafter for the sake of illustration. In step S24, 25 GO terms whose number of levels is smaller than 3 are removed, and 823 GO terms of which each GO term is composed of only one gene are removed. In step S25, for each of the GO terms, a component difference “Diff( )” between the GO term and each of the child members thereof is computed from the GO term which is a root node of the GO tree relationship, and any GO term whose component difference is zero is removed from the GO tree relationship. There are 400 GO terms removed in this step. In steps S26 and S27, there are 6 major proper clusters of the GO terms, which are the proper clusters that satisfy the condition that the P-value is smaller than 0.05, and which are listed in the following table:

| | | Bonferroni |
|---|---|---|
| Cluster | GO term | correction |
| 1 | modification-dependent | 0.006 |
| | macromolecule catabolic | |
| | process | |
| | cellular protein metabolic | |
| | process | |
| | cellular protein catabolic | |
| | process | |
| | protein catabolic process | |
| 2 | response to DNA damage | 0.0009 |
| | stimulus | |
| | macromolecule metabolic | |
| | process | |
| | macromolecule biosynthetic | |
| | process | |
| | DNA repair | |
| | biosynthetic process | |
| | cellular response to stress | |
| | DNA metabolic process | |
| | cellular response to stimulus | |
| | nucleotide-excision repair | |
| | DNA biosynthetic process | |
| | DNA replication | |
| | DNA strand elongation | |
| | response to stress | |
| | DNA-dependent DNA | |
| | replication | |
| | nitrogen compound metabolic | |
| | process | |
| | nucleobase, nucleoside, | |
| | nucleotide and nucleic acid | |
| | metabolic process | |
| | cellular macromolecule | |
| | biosynthetic process | |
| | nucleotide-excision repair, | |
| | DNA gap filling | |
| 3 | regulation of protein | 0.002 |
| | serine/threonine kinase activity | |
| | regulation of phosphorylation | |
| | regulation of cyclin-dependent | |
| | protein kinase activity | |
| | regulation of protein amino acid | |
| | phosphorylation | |
| 4 | male meiosis | 0.004 |
| | organelle organization | |
| | male meiosis I | |
| | male gamete generation | |
| | meiosis I | |
| | M phase | |
| 5 | regulation of nitrogen | 0.0009 |
| | compound metabolic process | |
| | regulation of primary metabolic | |
| | process | |
| | transcription initiation | |
| | transcription from RNA | |
| | polymerase II promoter | |
| | RNA metabolic process | |
| | regulation of RNA metabolic | |
| | process | |
| | regulation of cellular | |
| | biosynthetic process | |
| | regulation of gene expression | |
| 6 | positive regulation of helicase | 0.02 |
| | activity | |
| | regulation of helicase activity | |
| | positive regulation of hydrolase | |
| | activity | |

Step S28: Major GO terms are determined based on the GO tree relationship determined in step S23 and the GO term sets (major proper cluster) determined in step S27. In this step, a forest relationship defining at least one child tree is obtained by corresponding each of the GO term sets determined in step S27 (major proper cluster) to the GO tree relationship determined in step S23, and the major GO terms are determined according to the parent tree nodes of the forest relationship, where the parent tree node is defined by that, in the GO tree relationship, a higher-ranked one of any two tree nodes having a direct dependency relationship therebetween is defined as a parent tree node of a lower-ranked one of said two tree nodes. Then, each of the single-node child trees which is formed with only one GO term is removed from the forest, and a reference number, which represents how many times the GO term is referenced in the forest relationship (e.g., number of the parent tree nodes of the GO term in the forest relationship), is computed for each of the GO terms. A larger reference number indicates that the biological significance of the GO term is higher. In this embodiment, the major GO terms are determined by comparing number of the parent tree nodes associated with each of the GO terms with a threshold number, which is a sum of an average and a variance of number of the parent tree nodes of non-isolated GO terms in the forest relationship. The GO terms whose number of the parent nodes is greater than the threshold number are selected from each of the major proper clusters to be the major GO terms of the major proper cluster. Relationships between each of the major GO terms and the other GO terms of the corresponding major proper cluster may be classified into three types as follows:

1. Child trees obtained using the major GO term as a root node are adopted to be references of the annotation of biological functions.

2. If the major GO term has no child tree node in the corresponding major proper cluster, the parent tree nodes thereof are adopted to be references of the annotation.

3. When the major proper cluster does not have any GO term whose number of the parent nodes is greater than the threshold number, but each of the tree nodes has only one parent tree node except for the highest ranked node, the child tree forms a chain relationship. If the length of the chain relationship is equal to or larger than 2, the cluster is clustered by annotations of each level of specific biological function, and is adopted to be references of the annotation.

Each of the GO terms that satisfies one of the above conditions annotates specific functions of the gene composition of the GO term, and may be a reference for determining cellular component where a reaction occurs, molecular function, and influenced biological process.

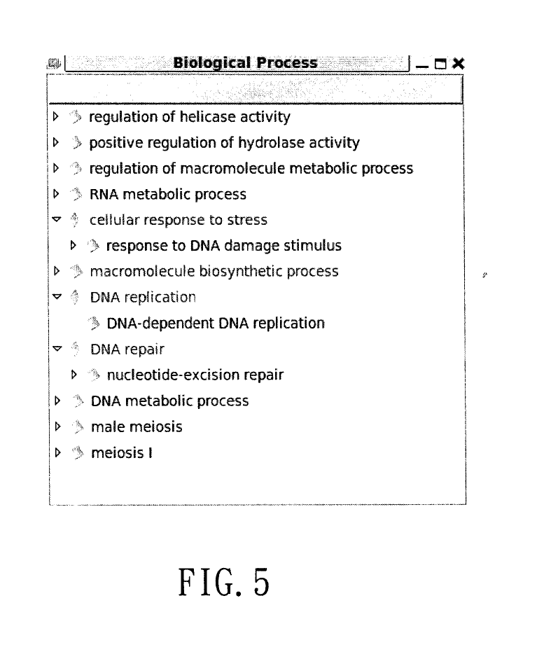

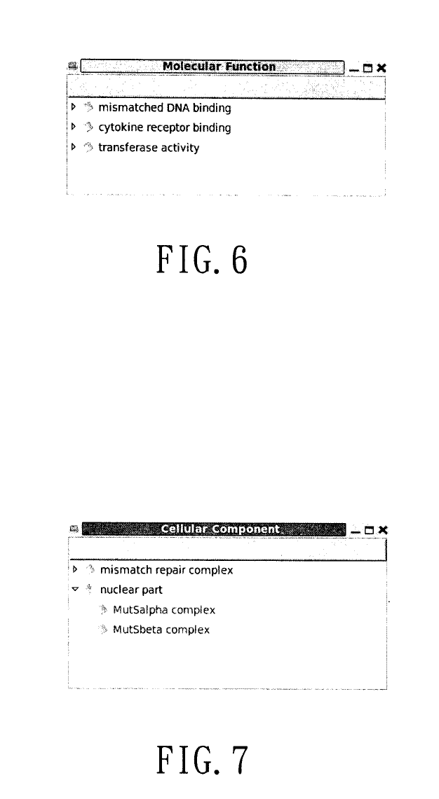

In this embodiment, there are 6 clusters having statistical significance (major proper clusters, whose corrected P-value<0.05 after multiple testing correction). The reference numbers of the non-isolated GO terms are respectively computed for each of the major proper clusters using a sum of an average and a variance of number of the parent tree nodes as the threshold number for determining the major GO terms and determining the annotation reference of the biological functions according to the three conditions illustrated in step S28, and the results are shown in FIGS. 5 to 7. In FIG. 5, each of the GO terms marked in red (including cellular response to stress, macromolecule biosynthetic process, DNA replication, and DNA repair) is one of the major GO terms whose reference number is larger than the threshold number. By the same way, the results associated with the molecular function domain are shown in FIG. 6, and the results associated with the cellular component domain are shown in FIG. 7.

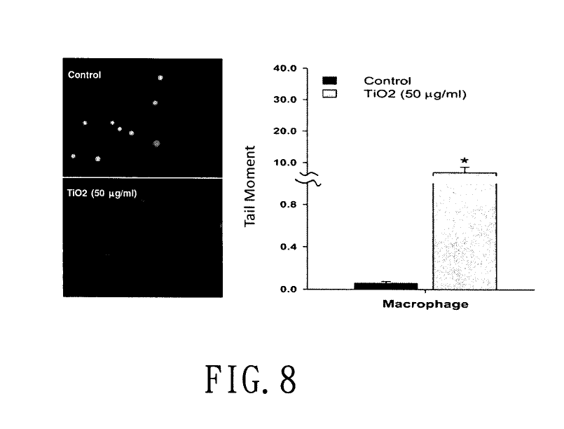

The function annotations of the major GO terms indicate that the biological processes of the genes are majorly related to DNA damage, the molecular functions are DNA binding, and the process is occurred in nucleus, i.e., cellular component. These function annotations obviously suggest that the TiO₂ nanoparticles lead to genotoxicity generation of the macrophages, resulting in DNA damage. The assumption can be confirmed by DNA comet assay. Referring to FIG. 8, the results of comet assay indicate that the TiO₂ nanoparticles truly result in DNA damage of the macrophages. The bottom-left image in FIG. 8 indicates that the DNAs are released from the nucleus of the damaged macrophages, and move toward an anode side, and thus, a comet tail is produced. The top-left image in FIG. 8 indicates that the DNAs of the undamaged macrophages are spherical. The result of the tail moment shown at the right side of FIG. 8 indicates that DNA damages of the macrophages are truly caused by the TiO₂ nanoparticles.

To sum up, since numbers of the genes involved in the reaction are different among each of the pathways and the genes have different properties thereamong, it is inappropriate to perform screening with a threshold number based on genes. According to this invention, the statistical significance is estimated based on pathways, and the relationships among the pathways are considered to keep the probably related genes, so as to find out the function annotations of the genes in the biological reaction with assistance of Gene Ontology. Therefore, the genes obtained by this method are in a more precise range and are more directly associated with the biological reaction.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A machine-implemented method for analyzing a genome-wide gene expression profiling, said machine-implemented method comprising:
a) searching at least one pathway database using genes in the genome-wide gene expression profiling as an index to find pathways;
b) screening the pathways found in step a) according to expression levels of the genes in the genome-wide gene expression profiling for identifying screened pathways that have statistical significance;
c) establishing pathway sets according to the genes associated with the screened pathways identified in step b), each of the pathway sets including a portion of the screened pathways; and
d) determining, for each of the pathway sets, biological information of the genes that are common to at least two of the screened pathways in the pathway set, wherein the determining of the biological information makes reference to correlation between at least one of the genes and gene ontology (GO) terms.

2. The machine-implemented method as claimed in claim 1, wherein step c) includes:
c-1) determining a network relationship among the screened pathways, wherein, in the network relationship, each of the screened pathways is associated with a vertex, and a pair of the screened pathways that are commonly associated with common genes are linked together by an edge;
c-2) computing, for each of the edges in the network relationship, a value that indicates statistical significance based on connectivity of the edge, and removing from the network relationship any edge whose value thus computed does not conform with a predetermined criterion;
c-3) after sub-step c-2), computing, for each of the edges remaining in the network relationship, a cluster coefficient based on the connectivity of the edge;
c-4) determining, according to the cluster coefficients computed in sub-step c-3), a clustering dendrogram relationship among the pathway sets, wherein each node of the clustering dendrogram relationship is associated with a pathway set that includes at least one of the screened pathways; and
c-5) removing, from the clustering dendrogram relationship, any pathway set that does not satisfy a clustering condition.

3. The machine-implemented method as claimed in claim 2, wherein sub-step c-2) includes:
c-2-1) computing, for each of the edges, the connectivity based on the gene expression level of the gene associated with the edge;
c-2-2) computing, for each of the edges, an artificial connectivity according to randomly selected genes having a same number as that of the genes associated with the edge;
c-2-3) repeating sub-step c-2-2) according to a sampling size, and computing, for each of the edges, a statistical probability (P-value), according to results of repetitions of sub-step c-2-2); and
c-2-4) removing from the network relationship any edge whose P-value thus computed is greater than a predetermined value.

4. The machine-implemented method as claimed in claim 3, wherein, in sub-step c-2-1), the connectivity G is computed using:
$${C}_{e} = {C}_{m , n} = \frac{{\sum }_{g ∈ m ⋂ n} \vert {log}_{2} ( \overline{g} ) \vert}{min [ {S}_{m} , {S}_{n} ]}$$
where e is the edge linking a pathway m and a pathway n, m∩n is a set of the genes commonly associated with the pathway m and the pathway n, g̅ is the expression ratio between the experimental group and the control group of a gene (g) commonly associated with the pathway m and the pathway n, Sₘ is the pathway activity score of the pathway m, and Sₙ is the pathway activity score of the pathway n.

5. The machine-implemented method as claimed in claim 4, wherein, in sub-step c-2-2), the artificial connectivity C_{artif} is computed using:
$${C}_{artif} = \frac{{\sum }_{g ∈ o} \vert {log}_{2} ( \overline{g} ) \vert}{min [ {S}_{m} , {S}_{n} ]}$$
where o is the set composed of the randomly selected genes.

6. The machine-implemented method as claimed in claim 5, wherein, in sub-step c-2-3), the P-value Pₑ is computed using:
$${P}_{e} = \frac{{\sum }_{k = 1}^{M} {I}_{k}}{M} , and {I}_{k} = \{ \begin{matrix}1 \vert {C}_{e} \leq {C}_{artif} \\ 0 \vert {C}_{e} < {C}_{artif}\end{matrix} \}$$
where M is the sampling size.

7. The machine-implemented method as claimed in claim 1, wherein, in step d), the correlation is obtained from a gene ontology database that includes the GO terms, each of the GO terms belonging to one of ontology domains, a lower-ranked one of two of the GO terms having a direct dependency relationship therebetween being defined as a child member of a higher-ranked one of said two of the GO terms, said step d) including:
d-1) determining screened common genes that are commonly associated with at least two of the screened pathways;
d-2) searching the gene ontology database to obtain the GO terms corresponding to the screened common genes;
d-3) determining a GO tree relationship according to the dependency relationships among the GO terms, wherein, in the GO tree relationship, each of the GO terms is associated with a tree node, and has a gene composition that is composed of the screened common genes and that corresponds to the GO term and the child member thereof;
d-4) establishing GO term sets according to the GO terms found in sub-step d-2) and the screened common genes associated therewith, each of the GO term sets including a portion of the GO terms found in sub-step d-2); and
d-5) determining major GO terms based on the GO tree relationship determined in sub-step d-3) and the GO term sets determined in sub-step d-4).

8. The machine-implemented method as claimed in claim 7, wherein, in the GO tree relationship, a higher-ranked one of any two tree nodes having a direct dependency relationship therebetween is defined as a parent tree node of a lower-ranked one of said two tree nodes, and in sub-step d-5), a forest relationship defining at least one child tree is obtained by corresponding each of the GO term sets determined in sub-step d-4) to the GO tree relationship determined in sub-step d-3), and the major GO terms are determined according to the parent tree nodes of the forest relationship.

9. The machine-implemented method as claimed in claim 8, wherein, in sub-step d-5), the major GO terms are determined by comparing number of the parent tree nodes associated with each of the GO terms with a threshold number.

10. The machine-implemented method as claimed in claim 9, wherein the threshold number is a sum of an average and a variance of number of the parent tree nodes of non-isolated GO terms in the forest relationship.

11. The machine-implemented method as claimed in claim 7, wherein sub-step d-3) includes:
computing, for each of the GO terms, a component difference between the GO term and each of the child members thereof, and removing from the GO tree relationship any GO term whose component difference is zero.

12. The machine-implemented method as claimed in claim 11, wherein the component difference is a total number of differences in the screened common genes between the GO term and each of the child members thereof.

13. The machine-implemented method as claimed in claim 7, wherein sub-step d-4) includes
d-4-1) determining a network relationship among the GO terms, wherein, in the network relationship, each of the GO terms is associated with a vertex, and a pair of the GO terms that are commonly associated with common genes are linked together by an edge;
d-4-2) computing connectivity for each of the edges in the network relationship;
d-4-3) computing, for each of the edges in the network relationship, a cluster coefficient based on the connectivity of the edge;
d-4-4) determining, according to the cluster coefficients computed in sub-step d-4-3), a clustering dendrogram relationship among the GO term sets, wherein each of the GO term sets is associated with a node of the clustering dendrogram relationship and includes at least one of the GO terms; and
d-4-5) removing, from the clustering dendrogram relationship, any GO term set that does not satisfy a clustering condition.
